(19) United States
(12) Patent Application Publication
(10) Pub. No.: US 2005/0076004 A1
(43) Pub. Date: Apr. 7, 2005

(54) Computer, database generating method for electronic picture book service, photographed subject information providing method, recording medium, and computer data signal

(76) Inventors: Hiroyuki Yanagisawa, Chiba (JP); Yasushi Yamamoto, Kanagawa (JP); Yoshiaki Nishizaki, Kanagawa (JP)

Correspondence Address: MORRISON & FOERSTER LLP, 1650 TYSONS BOULEVARD, SUITE 300, MCLEAN, VA, 22102, US

(21) Appl. No.: 10/952,554

(22) Filed: Sep. 29, 2004

(30) Foreign Application Priority Data
Sep. 30, 2003 (JP) 2003-341939
Sep. 30, 2003 (JP) 2003-342438

(51) Int. Cl. G06F 7/00

(52) U.S. Cl. 707/1

(57) ABSTRACT

A management computer, which is connected to a database that registers an image of an object and attribute information correlated, receives a photographed image of a photographed subject and photographed condition information, from a cellular phone unit, and obtains information relating to the photographed subject, from the received photographed condition information. Then, the management computer matches the information relating to the obtained photographed subject, with the attribute information registered in the database, matches the received photographed image with the images registered in the database, based on the matching result of information relating to the photographed subject, to specify the registered image corresponding to the photographed subject. The management computer reads the attribute information that is registered being correlated with the specified registered image, from the database, and sends the information to the cellular phone unit.

### BACKGROUND OF THE INVENTION

1. Field of the Invention

The present invention relates to a computer and method, etc., for generating a database for electronic picture book service, for providing information concerning a photographed subject.

2. Description of the Related Art

In recent years, usage of camera attached cellular phone units wherein a photographing function is added to the cellular phone unit is becoming more and more popular. Users of the camera attached cellular phone unit can easily photograph subjects anytime and anywhere, and send the photographed image by an e-mail function of the cellular phone unit. It is very useful if an animal or plant, etc., is photographed with this kind of camera attached cellular phone unit, and the name, etc. of the photographed animal or plant, etc., can be searched.

For example, in Unexamined Japanese Patent Application KOKAI Publication No. 2003-44497, a device for photographing an object using a camera attached cellular phone unit, sending the photographed image to a service center, searching a resembling image at the side of the server center, and sending back the search result to the requester, is disclosed. Also, for example, in Unexamined Japanese Patent Application KOKAI Publication No. 2000-44497, and Unexamined Japanese Patent Application KOKAI Publication 2000-285141, systems for searching an image resembling to a reference image, using characteristic amount of the reference image and the characteristic amount of each image in the image database, are disclosed.

However, in the above systems, even if the image registered in the database and the photographed image are the same image, it is not acknowledged as the same image, unless the two images resemble. Therefore, in a case where the photographed condition (for example, season, time, and weather, etc., at the time of photographing) of the photographed subject and the registered images in the database differs, even if a same image as the photographed subject is registered, it can not be acknowledged as the same image, and a same image can not be searched.

In a case where an image corresponding to the photographed subject is searched from a database, there are many cases where it is difficult to specify that photographed subject, only with the photographed image data. For example, having the user input information that would aid specifying the photographed subject can be considered, but in this case, it is a burden for the user, and the processing efficiency is not well.

### SUMMARY OF THE INVENTION

The present invention has been made in consideration of the above, and an object is to provide a method for generating a database for electronic picture book service in order to provide information concerning a photographed subject with a high accuracy, and a photographed subject information providing method, etc.

Another object of the present invention is to provide a photographed subject information providing method, etc., that can provide information concerning the photographed subject, by car g out an efficient highly accurate search.

To achieve the above objects, a computer according to a first aspect of the invention, is a computer for generating a database used in an electronic picture book service which provides information relating to a received photographed image, to the sender, wherein
an image and attribute information of the image are correlated with the database, and
the computer comprises:
a receiving unit which receives a reference image from a reference terminal, via a network;
a calculating unit which calculates the characteristic amount of the received reference image;
a resembling degree calculating unit which calculates the resembling degree of images, based on the calculated characteristic amount of the reference image, and the characteristic amount of the image registered in the database;
a specifying unit which specifies the registered image of the same photographed subject as the reference image, based on the calculated resembling degree; and
a registering unit which registers attribute information correlated with the specified registered image, to the database, correlating the information to the reference image.

The specifying unit may temporarily register the attribute information correlated with the specified registered image, correlating the information with the reference image, and may send information urging confirmation of the temporarily registered content, to the terminal of the confirmer; and
the registering unit may receive a confirmation result from the terminal of the confirmer, and may change the temporarily registering to an official registering, based on the confirmation result.

The specifying unit may:
extract the registered images that have a resembling degree equal to or higher than a predetermined value, based on the calculated resembling degree;
send the extracted registered images to a referer terminal;
receive information indicating the registered image that the referer designates from the extracted registered images; and
temporarily register the attribute information that is correlated with the registered image that the received information indicates, correlating the information with the reference image.

The specifying unit may:
determine the number of registered images that are to be displayed on a screen, based on the calculated resembling degree; and
generate screen data that displays the determined number of registered images of the extracted registered images, and send the data to the referer terminal.

The receiving unit may receive photographed information concerning the reference image, together with the reference image; and
the resembling degree calculating unit may search the registered images correlated with a search key, setting the photographed information as the search key, and respectively calculate the resembling degree with the reference image, concerning the searched registered images.

The referer terminal may be a cellular phone unit that has a digital camera embedded.

A computer according to a second aspect of the invention, is connected to a database that has an image of an object and attribute information correlated, comprising:
a receiving unit which receives a photographed image of a photographed subject and photographed condition information, from a user terminal;
an obtaining unit which obtains information relating to the photographed subject, from the received photographed condition information;
an attribute matching unit which matches the information relating to the obtained photographed subject, with the attribute information registered in the database;
an image matching unit which matches the received photographed image with the images registered in the database, based on the matching result of information relating to the photographed subject, and specifies the registered image corresponding to the photographed subject; and
a sending unit which reads the attribute information that is registered being correlated with the specified registered image, from the database, and sends the information to the user terminal.

The photographed condition information may include data of the photographed distance to the photographing subject, and focal length at the time of photographing;
the obtaining unit may obtain the actual size of the photographed subject, based on the photographing distance and the focal length, as information relating to the photographed subject; and
the attribute matching unit may match information of the size of the photographed subject, with the attribute information.

The photographed condition information may include data concerning the photographed time;
the obtaining unit may obtain information of the photographed time as information relating to the photographed subject; and
the attribute matching unit may match the information of the photographed time with the attribute information.

The photographed condition information may include data concerning photographed direction;
the obtaining unit may obtain photographing direction, based on data concerning the photographing direction, as information relating to the photographed subject; and
the attribute matching unit may match information of the photographing direction with the attribute information.

The photographed condition information may include information concerning photographing place;
the obtaining unit may obtain information of the photographing place, as information relating to the photographed subject; and
the attribute matching unit may match information of the photographing place with the attribute information.

The photographed condition information may include information conceding photographing time and photographing place;
the obtaining unit may obtain weather information based on information concerning the photographing time and the photographing place, as information relating to the photographed subject; and
the attribute matching unit may match the weather information with the attribute information.

A method for generating a database for electronic picture book service according to a third aspect of the invention, is a method for generating a database used in an electronic picture book service which provides information relating to a received photographed image, to the sender, wherein a computer:
receives a reference image from a reference terminal, via a network;
calculates the characteristic amount of the received reference image;
calculates the resembling degree of images, based on the calculated characteristic amount of the reference image, and the characteristic amount of the image registered in the database;
specifies the registered image of the same photographed subject as the reference image, based on the calculated resembling degree; and
registers attribute information correlated with the specified registered image, to the database, correlating the information to the reference image.

The computer may:
temporarily register the attribute information correlated with the specified registered image, correlating the information with the reference image;
send information urging confirmation of the temporarily registered content, to the terminal of the confirmer; and
receive a confirmation result from the terminal of the confirmer, and change the temporary registration to an official registering, based on the confirmation result;
in specifying the registered image that has the same photographed subject as the reference image.

The computer may:
extract the registered images that have a resembling degree equal to or higher than a predetermined value, based on the calculated resembling degree;
send the extracted registered images to a referer terminal;
receive information indicating the registered image that the referer designates from the extracted registered images; and
temporarily register the attribute information that is correlated with the registered image that the received information indicates, correlating the information with the reference image,
in temporarily registering the reference image.

The computer may:
determine the number of registered images that are to be displayed on a screen, based on the calculated resembling degree; and
generate screen data that displays the determined number of registered images of the extracted registered images, and send the data to the referer terminal,
in sending the extracted registered image to the referer terminal.

The computer may:
receive photographed information concerning the reference image, together with the reference image;
search the registered images correlated with a search key, setting the photographed information as the search key, and respectively calculate the resembling degree with the reference image, concerning the searched registered images,
in receiving the reference image from the referer terminal.

The referer terminal may be cellular phone unit that has a digital camera embedded.

A photographed subject information providing method according to a fourth aspect of the invention, is a method wherein a computer, which is connected to a database that registers an image of an object and attribute information correlated, executes the steps of:
receiving a photographed image of a photographed subject and photographed condition information, from a user terminal;
obtaining information relating to the photographed subject, from the received photographed condition information;
matching the information relating to the obtained photographed subject, with the attribute information registered in the database;
matching the received photographed image with the images registered in the database, based on the matching result of information relating to the photographed subject, and specifying the registered image corresponding to the photographed subject; and
reading the attribute information that is registered being correlated with the specified registered image, from the database, and sending the information to the user terminal.

The photographed condition information may include data of the photographed distance to the photographing subject, and focal length at the time of photographing;
the computer may obtain the actual size of the photographed subject, based on the photographing distance and the focal length, in obtaining information relating to the photographed subject; and
the computer may match information of the size of the photographed subject, with the attribute information, in matching information related to the photographed subject.

The photographed condition information may include data concerning the photographed time;
the computer may obtain information of the photographed time as information relating to the photographed subject, in obtaining information related to the photographed subject; and
the computer may match the information of the photographed time with the attribute information, in matching information related to the photographed subject.

The photographed condition information may include data concerning photographed direction;
the computer may obtain photographing direction, based on data concerning the photographing direction, as information relating to the photographed subject, in obtaining information related to the photographed subject; and
the computer may match information of the photographing direction with the attribute information, in matching information related to the photographed subject.

The photographed condition information may include information concerning photographing place;
the computer may obtain information of the photographing place, as information relating to the photographed subject, in obtaining information related to the photographed subject; and
the computer may match information of the photographing place with the attribute information, in matching information related to the photographed subject.

The photographed condition information may include information concerning photographing time and photographing place;
the computer may obtain weather information based on information concerning the photographing time and the photographing place, as information relating to the photographed subject, in obtaining information related to the photographed subject; and
the computer may match the weather information with the attribute information, in matching information related to the photographed subject.

A computer readable recording medium according to a fifth aspect of the invention, is a recording medium that stores a program for controlling a computer to execute:
a step of receiving a reference image from a reference terminal, via a network;
a step of calculating the characteristic amount of the received reference image;
a step of calculating the resembling degree of images, based on the calculated characteristic amount of the reference image, and the characteristic amount of the image registered in the database;
a step of specifying the registered image of the same photographed subject as the reference image, based on the calculated resembling degree; and
a step of registering attribute information correlated with the specified registered image, to the database, correlating the information to the reference image.

A computer readable recording medium according to a sixth aspect of the invention, is a recording medium that stores a program for controlling a computer to execute:
a step of receiving a photographed image of a photographed subject and photographed condition information, from a user terminal;
a step of obtaining information relating to the photographed subject, from the received photographed condition information;
a step of matching the information relating to the obtained photographed subject, with the attribute information registered in the database;
a step of matching the received photographed image with the images registered in the database, based on the matching result of information relating to the photographed subject, and specifying the registered image corresponding to the photographed subject; and
a step of reading the attribute information that is registered being correlated with the specified registered image, from the database, and sending the information to the user terminal.

A computer data signal embedded in a carrier wave according a seventh aspect of the invention, is a carrier wave indicating a program for controlling a computer to execute:
a step of receiving a reference image from a reference terminal, via a network;
a step of calculating the characteristic amount of the received reference image;
a step of calculating the resembling degree of images, based on the calculated characteristic amount of the reference image, and the characteristic amount of the image registered in the database;
a step of specifying the registered image of the same photographed subject as the reference image, based on the calculated resembling degree; and
a step of registering attribute information correlated with the specified registered image, to the database, correlating the information to the reference image.

A computer data signal embedded in a carrier wave, according to an eighth aspect of the invention, is a carrier wave indicating a program for controlling a computer to execute:
a step of receiving a photographed image of a photographed subject and photographed condition information, from a user terminal;
a step of obtaining information relating to the photographed subject, from the received photographed condition information;
a step of matching the information relating to the obtained photographed subject, with the attribute information registered in the database;
a step of matching the received photographed image with the images registered in the database, based on the matching result of information relating to the photographed subject, and specifying the registered image corresponding to the photographed subject; and
a step of reading the attribute information that is registered being correlated with the specified registered image, from the database, and sending the information to the user terminal.

### BRIEF DESCRIPTION OF THE DRAWINGS

These objects and other objects and advantages of the present invention will become more apparent upon reading of the following detailed description and the accompanying drawings in which:

FIG. 1 is a diagram for describing a structure example of an image management system according to a first embodiment of the present invention;

FIG. 2 is a diagram for describing a hardware structure of a management computer used in the image management system shown in FIG. 1;

FIG. 3 is a diagram indicating a data structure example of characteristic amount data;

FIG. 4 is a diagram indicating a data structure example of search key data;

FIG. 5 is a diagram indicating a data structure example of attribute data;

FIG. 6 is a diagram indicating a data structure example of register confirmation data;

FIG. 7 is a flowchart for describing processing in a case where image data is registered to an electronic picture book;

FIG. 8 is a flowchart for describing processing in a case where image data is registered to the electronic picture book;

FIG. 9 is a diagram for describing processing in a case where image data is registered to the electronic picture book;

FIG. 10 is a diagram for describing a structure example of an information providing system according to a second embodiment of the present invention;

FIG. 11 is a diagram for describing a hardware structure of a management computer used in the information providing system shown in FIG. 10;

FIG. 12 is a diagram indicating a data structure example of user information;

FIG. 13 is a diagram indicating a data structure example of area information;

FIG. 14 is a diagram indicating a data structure example of meteorological information;

FIG. 15 is a diagram indicating a data structure example of plant information;

FIG. 16 is a diagram indicating a data structure example of search condition information;

FIG. 17 is a flowchart for describing photographed information providing processing;

FIG. 18 is a flowchart for describing photographed information providing processing; and

FIG. 19 is a flowchart for describing photographed size calculating processing.

### DETAILED DESCRIPTION OF THE PREFERRED EMBODIMENTS

The embodiments of the present invention will be described with reference to the drawings.

### First Embodiment

In the first embodiment, an image management system which receives an image photographed by a camera attached portable telephone, which is a terminal of a referer, and registers information concerning the photographed subject that the received image indicates to an electronic picture book database, based on a registered image that resembles the received image, will be described. In the present embodiment, the user sends the image of an object (in the present embodiment, a plant) to an image management system, using a camera attached portable telephone, to find out information concerning that plant. In this way, in the present embodiment, the image management system functions as an system that manages an electronic picture book database concerning plants.

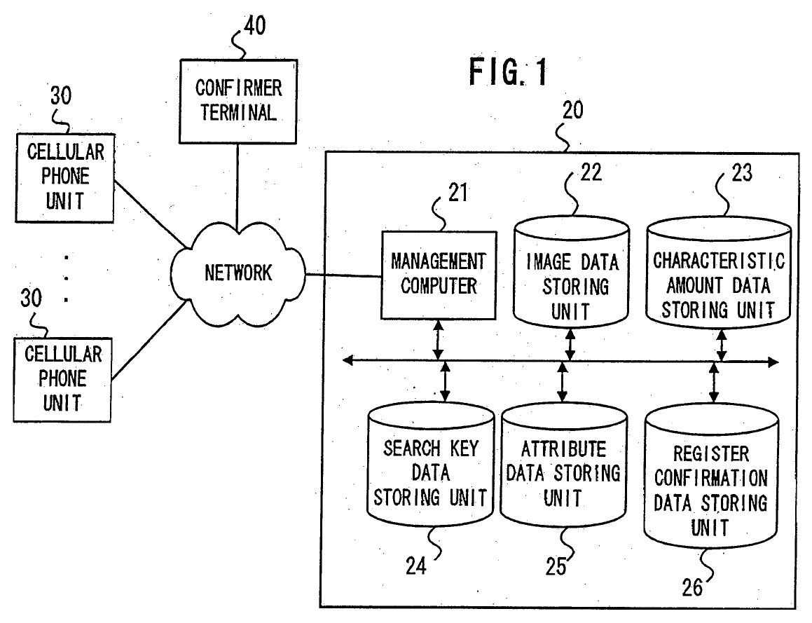

As shown in FIG. 1, a cellular phone unit 30 that has a digital camera embedded, and a confirmer terminal 40 can be connected to an image management system 20, via a network 50 such as the Internet, etc.

The cellular phone unit 30 is a camera attached cellular phone unit which the user uses. The cellular phone unit 30 photographs a photographing subject by the embedded digital camera, and sends the image data thereof to the image management system 20. The cellular phone unit 30 comprises a control unit such as a CPU, etc., a storing unit such as a RAM, a ROM, and a hard disk, etc., an input unit, a display unit, a communication unit, and a photographing unit, such as a camera, etc., and realizes photographing functions (digital camera functions), and communication functions, etc., by the control unit reading and executing a program stored in the storing unit. The user can find out information concerning a photographed subject using a picture book that the image management system 20 provides, by using the photographing function of the cellular phone unit 30 to photograph the photographing subject that he/she wants to find out, and sending the photographed image as a reference image, to the image management system 20.

The confirmer terminal 40 is a computer terminal used by a confirmer who confirms tie image and attribute information temporarily correlated with that image, and determines whether the image and the temporarily correlated attribute information should be officially registered as being correlated or not. The confirmer terminal 40 is a computer terminal that has a function of sending data via a network, and a function of displaying the received data, etc. The confirmer terminal 40 includes a control unit such as a CPU, etc., a storing unit such as a RAM, a ROM, and a hard disk, etc., an input unit such as a keyboard, and a mouse, etc., an output unit such as a display, etc., and a communication unit, etc., such as a modem, etc.

The image management system 20 carries out data processing of management and providing, etc., of various data, such as image data sent from the cellular phone unit 30, image data provided as the electronic picture book, and attribute data, etc. The image management system 20 comprises a management computer 21, and each database (an image data storing unit 22, a characteristic amount data storing unit 23, a search key data storing unit 24, an attribute data storing unit 25, and a register confirmation data storing unit 26). The management computer 21, the image data storing unit 22, the characteristic amount storing unit 23, the search key data storing unit 24, the attribute data storing unit 25, and the register confirmation data storing unit 26 are connected via a network.

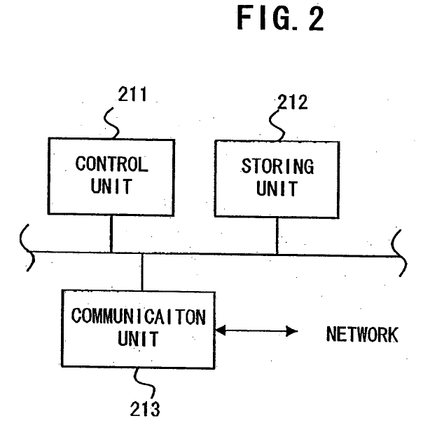

The management computer 21 carries out sending/receiving processing of data between the cellular phone unit 30 and the confirmer terminal 40, and processing, etc, of managing various information. For example, as shown in FIG. 2, the management computer 21 comprises a control unit 211 that includes a CPU, a RAM, and a ROM, etc:, a storing unit 323 that includes a hard disk, etc., and a communication unit 213, etc., that controls communication with another computer via the network, and by the control unit 211 executing a program, etc., stored in the storing unit 212, realizes a receiving unit, a calculating unit, a resembling degree calculating unit, and an image specifying unit.

The receiving unit receives reference image and photographed image information from the cellular phone unit 30, via the Internet, etc. The calculating unit carries out processing for calculating the characteristic amount of the received reference image. The resembling degree calculating unit sets the photographed image information as a search key, searches the registered images correlated with the search key, and calculates the characteristic amount of the searched registered images. Then, the resembling degree calculating unit carries out processing of calculating the resembling degree between the images, based on the calculated characteristic amount of the reference image and the characteristic amount of the registered images. The image specifying unit carries out processing for specifying a registered image that is the same photographed subject as the reference image, based on the calculated resembling degree. Concretely, the image specifying unit extracts registered images that have a resembling degree that is equal to or higher than a predetermined value, and sends the extracted images to the cellular phone unit 30 of the referer. At this time, the number of registered images that are displayed on the screen sent to the cellular phone unit 30, is determined based on the calculated resembling degree. Then, the image specifying unit specifies the attribute information correlated with the registered image designated by he referer, and temporarily registers the attribute information correlated with the reference image. Thereafter, the image specifying unit sends information urging confirmation of the temporarily registered content, to the confirmer terminal 40. The registering unit receives the confirmation result from the confirmer terminal 40, and carries out processing of registering the attribute information correlated with the registered image that is specified as the same photographed subject as the reference image, correlating the attribute information with the reference image, based on the confirmation result.

Registered image data is stored in the image data storing unit 22. Registered image data indicates for example, image data provided by picture book publishers and flower shops, etc., and images that are permitted to be registered by the confirmer (reference image), etc. In the present embodiment, image data of a plurality of registered images is stored in the image data storing unit 22, in advance.

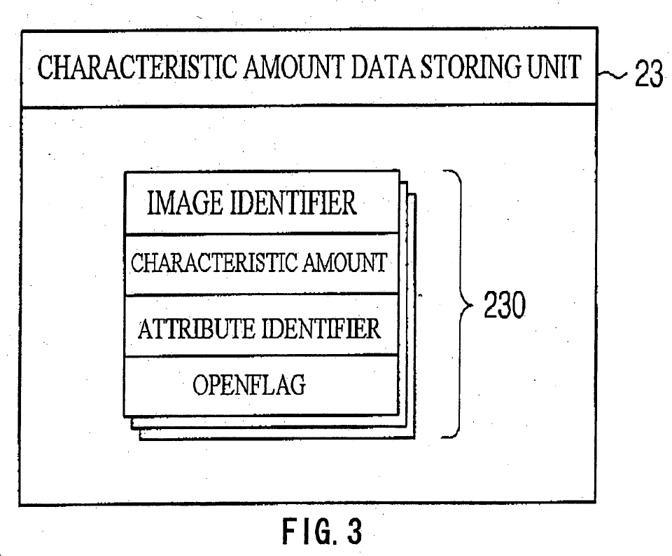

Characteristic amount data 230 concerning the characteristic amount of the registered image data stored in the image data storing unit 22, is stored in the characteristic amount data storing unit 23. In a case where the registered image data is stored in the image data storing unit 22, the characteristic amount data 230 is generated and stored by the control unit 211. For example, as shown in FIG. 3, the characteristic amount data 230 includes data such as image identifier, characteristic amount, attribute identifier, and openflag, etc. At the data region of the image identifier, data of an identifier for specifying the registered image data is stored. At the data region of the characteristic amount, data concerning the characteristic amount of the image data is stored. For example, the control unit 211 calculates the characteristic amount of the registered image data. In the present embodiment, data quantifying each of the overall color, color distribution, outline form, and pattern of the image data, is stored as the characteristic amount. The characteristic amount may be calculated by using a well-known art of calculating the characteristic amount of images. At the data region of the attribute identifier, data of the identifier for specifying attribute data is stored. At the data region of the openflag, a flag indicating whether the registered image data is to be a target for searching (whether the registered image is to be disclosed or not) is stored in the electronic picture book provided by the image management system 20. In the present embodiment, in a case where the openflag is set to “can be disclosed”, the registered image data becomes a searching target. The openflag is set by the control unit 211, based on the authentication result determined by the confirmer.

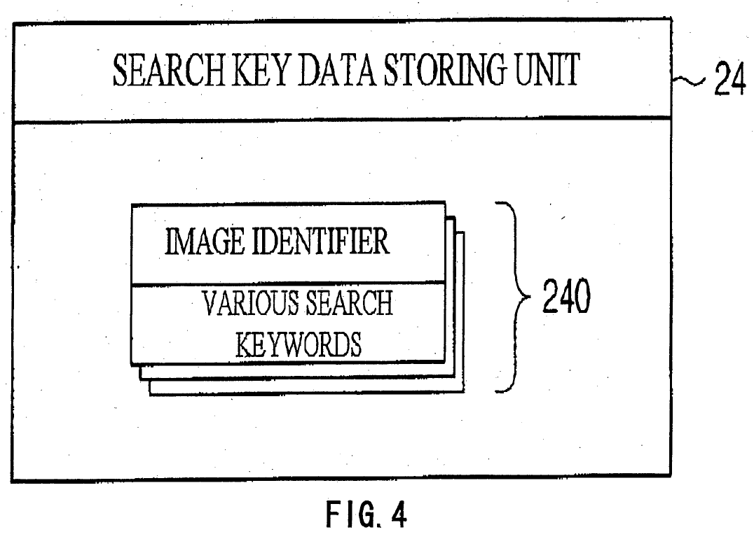

Search key data 240 concerning a search keyword of image data is stored in the search key data storing unit 240. Search key data 240 is generated by the control unit 211, and stored, in a case where an image data is stored in the image data storing unit 22. For example, as shown in FIG. 4, the search key data 240 includes the image identifier and various search keywords, according to the respective image data. At the data region of the image identifier, data of the identifier that specifies the image data registered in the image data storing unit 22, is stored. At the data region of various search keywords, data of various keywords for searching the image data is stored. In the present embodiment, keywords such as, photographing place, main photographed target size, weather, and vegetation zone, etc., are stored as the various keywords. These keywords are stored based on data stored in Exif format at the time the image is photographed, data provided from meteorological information providing sites, and data provided from map information providing sites, etc.

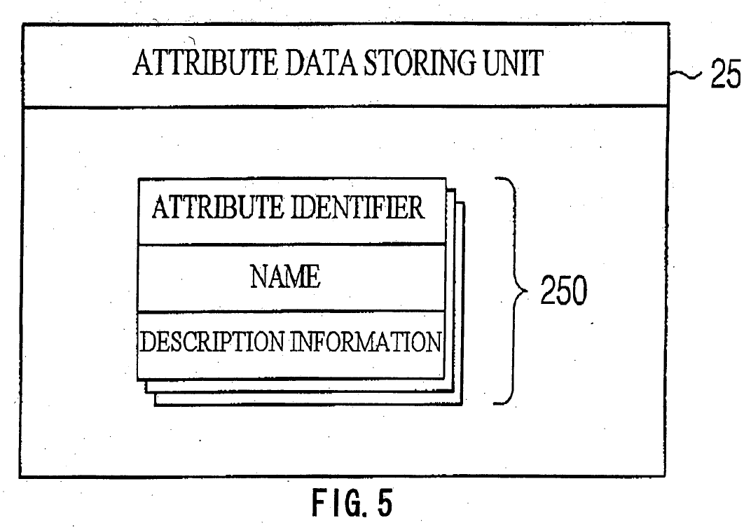

Attribute data 250 concerning descriptions of the type of the image of the photographed subject, which is displayed corresponding to the registered image, is stored in the attributed data storing unit 25. In a case where image data of a new type of photographed subject is registered, the attribute data 250 is generated by the control unit 211, and stored. For example, as shown in FIG. 5, the attribute data includes data of attribute identifier, name and description information according to the type of the photographed subject. At the data region of the attribute identifier, data of the identifier specifying the attribute data is stored. At the data region of name, data of the name of the photographed subject is stored. At the description information data region, data of description concerning the photographed subject is stored.

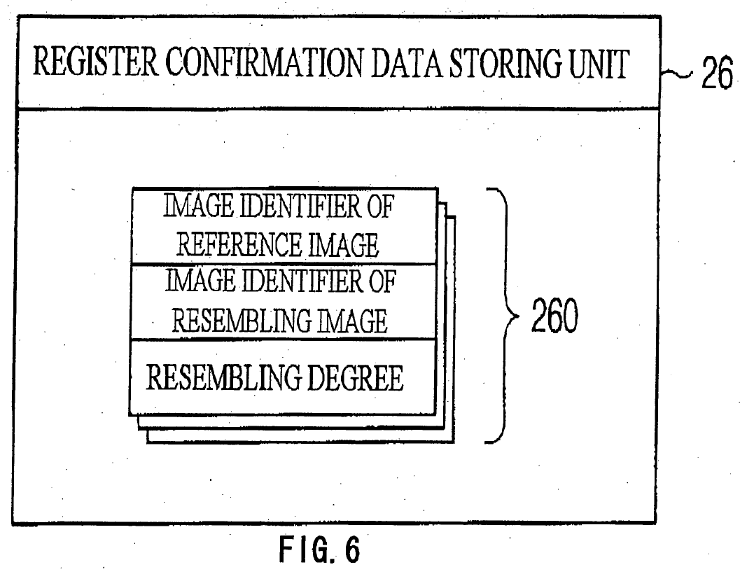

In a case where a new reference image is temporarily registered, register confirmation data 260 used for confirming the correlation of the reference image and the attribute information, is stored in the register confirmation data storing unit 26. The register confirmation data 260 is generated by the control unit 211 and stored, in a case where register concerning the reference image is permitted by the user who uses the cellular phone unit 30. For example, as shown in FIG. 6, register confirmation data 260 includes image identifier of the reference image, image identifier of the resembling images and data of the resembling degree, according to each reference image. At the data region of the image identifier of the reference image, data of the identifier specifying the reference image is stored. At the data region of the image identifier of the resembling image, data of the identifier specifying the registered image data selected by the user as the image resembling the reference image is stored. At the region of the resembling degree data, data of the resembling degree of the reference image data and the resembling image data is stored.

The storing unit 212 of the management computer 21 comprises a received data storing unit, a confirmer data storing unit, and a confirming request data storing unit. At the received data storing unit, image data of the reference image, photographing information of the image data of the reference image, the characteristic amount of image data of the reference image, and data concerning the search keyword of the reference image, are stored. At the point where these data are stored to the received data storing unit, register permitting by the user who carries out referring, and register confirmation by the confirmer, concerning the registered reference image, are not carried out.

Temporary identifier is added to the image data of the reference image received from the cellular phone unit 30, and image data of the reference image can be extracted by using the temporary identifier. In the image data of the reference image, photographed information received together with the image data of the reference image from the cellular phone unit 30, is correlated therewith, and stored. In a case where the characteristic amount conceding the reference image is calculated, data concerning the characteristic amount of image data of the reference image is stored correlated with the temporary identifier. In a case where data concerning the search keyword is generated based on the photographed information, the data is stored correlated with the temporary identifier.

At the confirmer data storing unit, confirmer data concerning the confirmer who is a specialist for authenticating whether the correlation is accurate or not based on the reference image and the image selected as the resembling image, is stored according to each confirmer. The confirmer data includes confirmer identifier for specifying the confirmer, a password for authenticating the confirmer, and an e-mail address, etc., of the confirmer. Confirmation request data concerning the confirmation request carried out towards the confirmer, is stored in the confirmation request data storing unit. The confirmation request data includes data concerning the confirmer identifier of the confirmer of the confirmation request destination and the image identifier of the image that is carried out the confirming request, and is generated and stored according to each confirmation request.

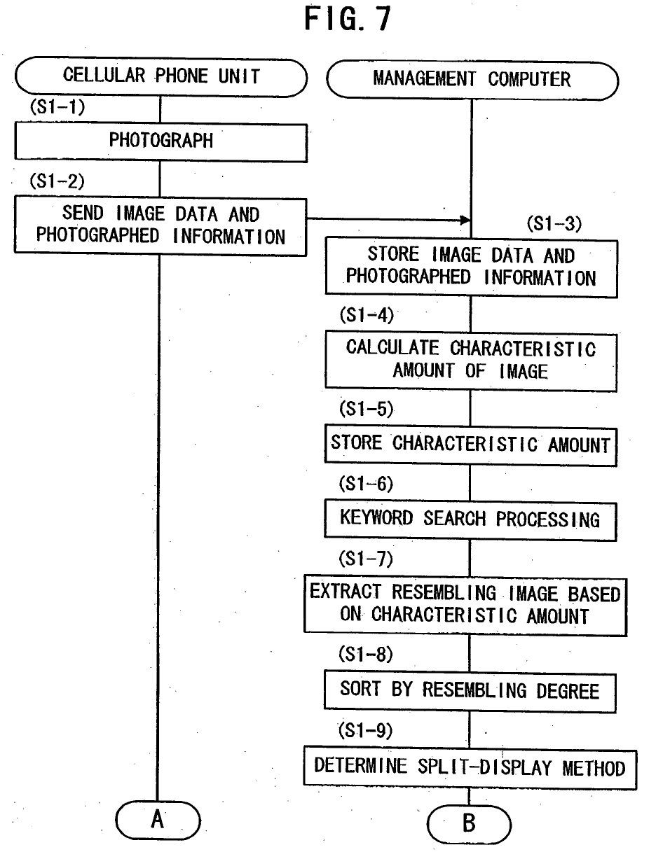

Next, processing of a case where image data photographed by the cellular phone unit 30 is registered to the electronic picture that the image management system provides, will be described with reference to FIGS. 7 to 9.

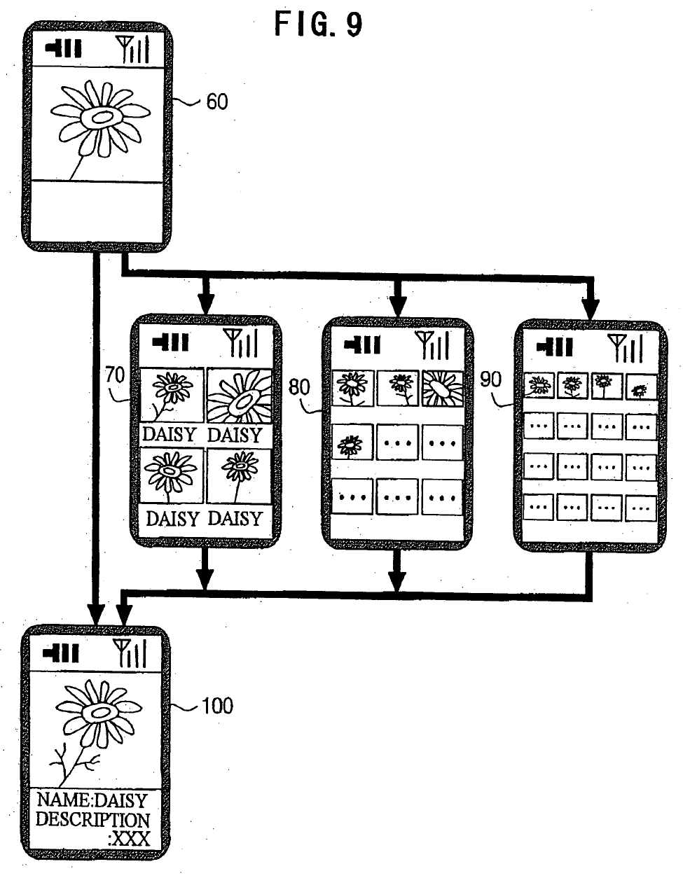

As shown in FIG. 7, first, the user photographs a photographing subject using a cellular phone unit 30 that has a digital camera embedded (step S1-1). In the present embodiment, because the image management system 20 provides an electronic picture book concerning plants, the user photographs a plant as the photographing subject. Then, the user confirms the photographed image at the display unit of the cellular phone unit 30. Here, as a display screen 60, shown in FIG. 9, the photographed image is displayed.

When the user carries out sending request operation to the management system 20, concerning the photographed subject, the cellular phone unit 30 sends the image data and the photographed information to the image management system 20 (step S1-2). The photographed information is stored in Exif format by the cellular phone unit 30, and is included in the image file together with the image data. As the photographed information, information such as, position information, photographed direction information, camera information (focal length, photographing distance, aperture value, and shutter speed), photographing angle (elevation angle) information, and information of photographed date, time, minute, and second, are included.

When the control unit 211 of the management computer 21 receives the image data and the photographed information from the cellular phone unit 30, the control unit 211 stores the received image data and the photographed information (step S1-3). Concretely, the control unit 211 of the management computer 21 adds a temporary identifier to the image data and the photographed information, and stores it to the received data storing unit 213. Then, the control unit 211 calculates the characteristic amount concerning each of the overall color, color distribution, outline form, and pattern of the received image data, using a well-known art of resembling image searching (step S1-4). The control unit 211 stores the calculated characteristic amount (step S1-5). Concretely, the control unit 211 correlates the calculated characteristic amount with the temporary identifier, and stores it to the received data storing unit.

Next, the control unit 211 carries out keyword search processing (step S1-6). Concretely, the control unit 211 generates a search keyword based on the photographed information stored in the received data storing unit. For example, the control unit 211 specifies the photographed place based on the position information of the photographed information, obtains the size of the photographed subject based on the focal length, the photographing distance, and the photographing angle of the photographed information, specifies the weather at the time the subject was photographed, based on the position information, information of the photographed year, month, day, time, minute, second of the photographed information, and information from a meteorological information providing site, and specifies the vegetation of the photographed place, based on the position information and vegetation information from a map information providing site. Then, the control unit 211 correlates the obtained information with the temporary identifier, and stores the information as the search keyword, to the received data storing unit. The control unit 211 searches the search key data storing unit 24 using the search keyword, and extracts every image identifier corresponding to the search keyword.

Then, concerning the registered image of every extracted image identifier, the control unit 211 calculates the resembling degree with the photographed image received from the cellular phone unit 30, using a well-known art of resembling image searching, to extract resembling images wherein the resembling degree is equal to or higher than a predetermined value (step S1-7). Concretely, the control unit 211 reads the data of the characteristic amount corresponding to each image identifier extracted using the search keyword, by searching the data from the characteristic amount data storing unit 23. Then, the control unit 211 plots the read characteristic amount and the characteristic amount of the received photographed image in a space adopting the characteristic amount to a coordinate axis. The control unit 211 obtains the distance of the received photographed image and each registered image narrowed down by the keyword search according to the type of the characteristic amount, using vector distance calculating method, and calculates the resembling degree of the entire characteristic amount by totaling the obtained distance of every type. In the searching of the characteristic amount data storing unit 23, only the characteristic amount data 230 whose openflag is set to “can be disclosed” is used as the search target. Then, the control unit 211 extracts the image identifier of the registered information wherein the resembling degree calculated as above, is equal to or higher than a predetermined value. In the present embodiment, for example, the predetermined value is 60 percent.

The control unit 211 sorts the extracted registered images by the resembling degree (step S1-8). The management computer 21 determines a split-display method using a predetermined function, based on the resembling degree of the sorted registered image (step S1-9).

In the present embodiment, the split-display method is determined based on the reference image and the highest resembling degree within the reference image, and the registered image. Concretely, the split-display method is carried out as below. For example, in a case where the highest resembling degree is equal to or higher than 90 percent, split-display of the screen is not carried out. In this case, as a display screen 100 shown in FIG. 9, one image is displayed on the display unit of the cellular phone unit 30. In a case where the highest resembling degree is equal to or higher than 80 percent and is lower than 90 percent, the display is divided into four parts. In this case, as a display screen 70, four images are displayed on the display unit of the cellular phone unit 30. In a case where the highest resembling degree is equal to or higher than 70 percent and is lower than 80 percent, the display is divided into nine parts. In this case, as a display screen 80, nine images are displayed on the display unit of the cellular phone unit 30. In a case where the highest resembling degree is equal to or higher than 60 percent and is lower than 70 percent, the display is divided into sixteen parts. In this case, as a display screen 90, sixteen images are displayed on the display unit of the cellular phone unit 30.

As shown in FIG. 9, the control unit 211 of the management computer 21 generates split-display screen data that arranges the images in an order from the higher resembling degree, by the determined split-display method, and sends the data to the cellular phone unit 30 (step S1-10). Concretely, the control unit 211 magnifies or reduces the image that is the displaying target in order for the image to correspond to the determined split-display method, so that the image is displayed, corresponding to the size of each split display section. Further, in a case of the one screen display shown in the display screen 100, based on the attribute identifier in the characteristic amount data 230 extracted based on the image identifier of the image, data of name and description information corresponding thereto, is extracted from the attribute data storing unit 25, and set in the screen data. In a case of a display divided into four parts, as shown in the display screen 70, based on the attribute identifier of the characteristic amount data 230 extracted based on the image identifier, data of name corresponding thereto, is extracted from the attribute data storing unit 25, and set in the screen data. Then, the control unit 211 sends the thus generated split-display data to the cellular phone unit 30.

On the other hand, the cellular phone unit 30 that receives the split-display screen displays a split-display screen on the displaying unit. The user determines whether there is the same type of image of the photographed subject, as the photographed subject of the reference image, within the images displayed on the split-display screen. In a case where the user determines that the image of the same type of photographed subject as the photographed subject of the reference image displayed on the screen, the user uses an operation unit of the cellular phone unit 30 to carry out operation for displaying the registered image that has the next highest resembling degree. In accordance with this operation, the cellular phone unit 30 sends a display request of the registered image that has the next highest resembling degree, to the management computer 21.

The control unit 211 of the management computer 21 that receives this request, generates split-display screen data so that each registered image is displayed in an order that the registered image that has the next highest resembling degree of the previously displayed registered image, and sends the data to the cellular phone unit 30. The cellular phone unit 30 displays the split-display screen data. The user searches the registered image concerning the same type of photographed subject as the photographed subject of the reference image, from the displayed data. In a case where the image of the photographed subject of the same type of image as the photographed subject of the reference image is not found, and the user still wants to search that image, the user carries out operation for displaying the registered image that has the next highest resembling degree, using the operating unit of the cellular phone unit 30, to continue the search of the registered image concerning the same type of photographed subject as the photographed subject of the reference image.

In a case where a split-display screen that is divided into four parts or more, is displayed, and the user determines that the image is the same type of photographed subject as the photographed subject of the reference image, the user carries out operation of selecting and determining that image. By this, the cellular phone unit 30 sends image selecting data including the image identifier of that image, to the management computer 21 (step S1-11). For example, when an operation for selecting and determining, concerning any one of the images of the image display unit that is divided into four parts (here, the upper left image), the cellular phone unit 30 sends image selection data including the image identifier of the image, to the management computer 21.

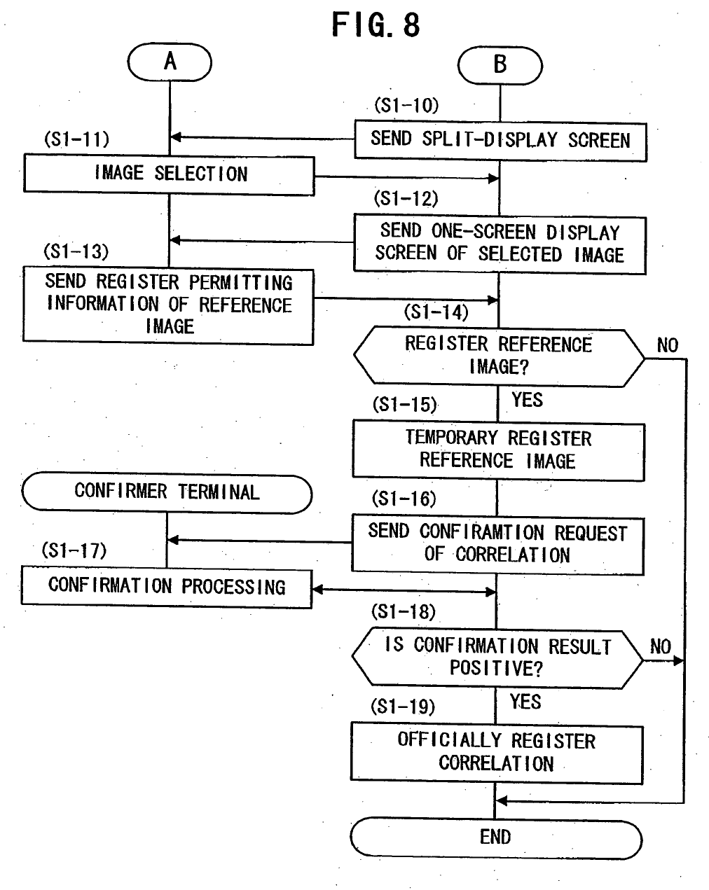

The control unit 211 that receives the image selection data generates display screen data of a screen displaying one screen of the selected image that the received data indicates, and sends it to the cellular phone unit 30 (step S1-12). Concretely, the control unit 211 extracts the attribute identifier from the characteristic amount data storing unit 23, based on the image identifier of the selected image, and extracts attribute data 250 from the attribute data storing unit 25 based on the attribute identifier. Then, the control unit 211 generates display screen data so that the image, the name, and description display of the attribute data 250 are displayed on one screen, and sends the data to the cellular phone unit 30. Concretely, at the displaying unit of the cellular phone unit 30, as the display screen 100 shown in FIG. 8, one image, and name and character display concerning the description are displayed, concerning the image selected by the user.

Next, the user compares the plant of the selected image and the plant that is the reference target, and determines whether the two images match or not. In a case where identity of the plants can be specified, the user can know the name and characteristics, etc., of the plant which is the reference target.

On the other hand, as a result of comparing the image of the plant selected by the user, and the image of the plant which is the reference target, there is a case where the two images do not match. In this kind of case, in a case where the user wants to further find out about the reference image, the user uses the operating unit of the cellular phone unit to return to the former split-display screen, and continues the search for the registered image concerning the same type of plant as the photographed subject.

Then, the control unit 211 detects the registered image concerning the same photographed subject as the photographed subject of the reference image, and in a case where information concerning the photographed subject is obtained, the user determines whether to permit or not to permit, registering of the reference image. In a case where the user determines whether to permit or not to permit registration, the user carries out selecting of whether to permit or not to permit registering, using the operating unit of the cellular phone unit 30. In accordance with the selection, the cellular phone unit 30 sends registration conriming data including the image identifier (temporary identifier) of the reference image, and a registering flag indicating whether the reference image can be registered or not, to the management computer 21 (step S1-13).

In a case where the register flag indicating “can be registered” is set in the received register confirmation data (step S1-14: YES), the control unit 211 of the management computer 21 carries out temporary registration of the reference image (step S1-15). Concretely, the control unit 211 extracts image data of the reference image registered in the received data storing unit of the storing unit 212, based on the temporary identifier of the reference image, and stores the image data to the image data storing unit 22, adding an image identifier to that image data The image identifier that is added at this time, may be newly generated, or the temporary identifier may be used. Further, the management computer 21 extracts the characteristic amount from the received data storing unit, based on the temporary identifier of the reference image. The management computer 21 also extracts the attribute identifier of the selected resembling image, from the characteristic amount data storing unit 23, based on the image identifier of the resembling image. Then, the control unit 211 generates the characteristic amount data 230 of the reference image, using the image identifier added to the reference image, the extracted characteristic amount, and the extracted attribute identifier, and stores the data to the characteristic amount data storing unit 23. Further, the control unit 211 generates the search keywords based on the photographed information, in step S1-6, and generates search key data 240 which includes the search keywords stored in the received data storing unit, and the image identifier. The management computer 21 also generates register confirmation data 260 which includes the image identifier of the reference image, and the image identifier of the selected resembling image, and stores the data to the register confirmation data storing unit 26.

Next, the control unit 211 sends the confirmation request of the correlation to the confirmer terminal 40 (step S1-16). Concretely, the control unit 211 extracts the e-mail address of the confirmer from the confirmer data storing unit of the storing unit 212, and sends an e-mail concerning the confirmation request of correlation of which the image identifier is designated, to the e-mail address. In a case where a plurality of confirmers are registered, in the present embodiment, the control unit 211 sends the confirmation request of correlation to one arbitrary person of the plurality of confirmers. Further, the control unit 211 stores the confirmer identifier of the confirmer who is the sending destination of the confirmation request of correlation, and the image identifier designated in the confirmation request, to the confirmation request data storing unit of the storing unit 212.

The confirmer who confirms the e-mail concerning the confirmation request of correlation, accesses to the image management system 20 using the confirmer terminal, and carries out confirmation processing of correlation (step S1-17). Concretely, the confirmer inputs the confirmer identifier and a password in a confirmer authenticating screen provided by the management computer 21, and carries out sending processing. By this, the confirmer terminal 40 sends the input confirmer identifier and the password to the image management system 20.

The control unit 211 of the management computer 21 of the image management system 20, authenticates the confirmer by matching the confirmer identifier and password stored in the confirmer data storing unit of the storing unit 212, with the received confirmer identifier and password.

In a case where the confirmer is authenticated, the control unit 211 extracts the image identifier from the confirmation request data storing unit of the storing unit 212, based on the confirmer identifier. Then, the control unit 211 generates confirmation screen data for confirming the image of the extracted image identifier. The confirmation screen data includes the temporarily registered image, the name and description information of the photographed subject, the image selected as the resembling image, and data for displaying the resembling degree. The temporarily registered image is set based on the image extracted from the image data storing unit 22, based on the extracted image identifier. Here, the attribute data 250 is specified by the attribute identifier extracted from the characteristic amount data storing unit 23, based on the image identifier. The resembling degree is the resembling degree of the register confirmation data 260. Then, the management computer 21 sends the generated confirmation screen data to the confirmer terminal 40.

The confirmer terminal 40 receives this confirmation screen data, and displays a confirmation screen based on the data. The confirmer looks at the temporarily registered image displayed on the confirmation screen, and determines whether the photographed subject of that image matches with the name and description information of the displayed photographed subject. At this time, the confirmer refers to the image that is selected as the resembling image and the resembling degree. Here, in a case where the confirmer determines that the photographed subject of the image that is temporarily registered matches with the displayed name and description information of the photographed subject, the confirmer approves correlation. The confirmer carries out input of approval/non approval of correlation, on the confirmation screen, and carries out sending processing. The confirmer terminal 40 sends approval/non approval data including the input data, to the image management system 20. Data concerning confirmer identifier, and image identifier and approval flag of the temporarily registered image, are included in the approval/non-approval data. In a case where the confirmation result is positive, (in a case where “approval” is input), the approval flag is set to “can be approved”, and in a case where “non approval” is input, the approval flag is set to, “can not be approved”.

Receiving the approval/non approval data, the control unit 211 of the management computer 21 searches whether the confirmation result is positive or not, based on the approval flag in the data. In a case where the confirmation result is positive (step S1-18: YES), the management computer 21 officially registers the correlation (step S1-19). Concretely, the control unit 211 searches the characteristic amount data storing unit.23, based on the image identifier, and sets the openflag of the specified characteristic amount data 230 to “can be disclosed”. Further, the control unit 211 searches the register confirmation data storing unit 26, setting the image identifier thereof as the image identifier of the reference image, and deletes the specified registered confirmation data 260.

On the other hand, in a case where the confirmation result is negative (step S1-18 : NO), the control unit 211 of the management computer sets “can not be disclosed” to the openflag, and deletes the corresponding register confirmation data 260. In a case where the user does not request registering of the reference image, i.e., in a case where a register flag “permit” is not set to the register confirmation data (step S-14: NO), the control unit 211 ends the processing concerning that image data.

As described above, according to the present embodiment, a database for an electronic picture book service which provides with a high accuracy, information concerning an image of a photographed subject, based on a registered image that resembles that image, can be generated.

In the above embodiment, the management computer 21 calculates the characteristic amount concerning the image data of the reference image received from the cellular phone unit 30, and calculates the resembling degree based on the characteristic amount of the reference image data and the characteristic amount of image data stored in the image data storing unit 22. Then, based on the resembling degree, the management computer 21 executes registration processing of correlation information of the reference image data and the attribute information correlated with the registered image data. Therefore, the reference image received from the cellular phone unit 30 and the attribute information correlated with the registered image that resembles the reference image, can be stored correlated with each other. By this, the number of registered image data can be increased, and a fulfilling electronic picture book service can be provided.

In the above embodiment, the management computer 21 caries out temporary registration based on the resembling degree, and sends information urging confirmation of correlation, to the confirmer terminal 40. Then, the management computer 21 changes the temporary registration to an official registration, based on the confirmation result received from the confirmer terminal 40. Therefore, because an official registration can be carried out after confirmation by a confirmer, image data can be registered based on an even more accurate judgment.

The management computer 21 receives image data of the reference image from the cellular phone unit 30, and calculates the characteristic amount of image data of the reference image. Then, the management computer 21 calculates the resembling degree of the reference image and the resembling registered image, based on the characteristic amount of the image data of the reference image and the characteristic amount of image data in the image data storing unit 22. By this, the registered image resembling the reference image can be searched using the cellular phone unit 30, and correlation of the attribute information and reference image correlated with the registered image, can be temporarily registered.

The management computer 21 sends information urging confirmation of correlation to the confirmer terminal 40, receives the confirmation result from the confirmer terminal 40, and officially registers the correlation, based on the confirmation result. Therefore, because an official registration can be carried out being correlated with attribute information, after the confirmation by a confirmer, image data can be registered based on an even more accurate judgment.

The management computer 21 sends the registered image (s) to the cellular phone unit 30, based on the resembling degree, urges matching of the photographed subject of the reference image and the photographed subject of the registered image (s), and receives the matching result from the cellular phone unit 30. Then, based on the received matching result, the management computer 21 temporarily registers the reference image and the attribute information correlated with the registered image, being correlated with each other. Because the user confirms the matching result, a resembling image can be specified by an even more accurate judgment.

The management computer 21 receives photographed information concerning the reference image, together with the image data of the reference image, and based on the photographed information, searches the registered images using the search key data storing unit 24. Therefore, the search becomes more accurate. Also, because photographed information that is automatically added at the time of photographing of the reference image, is used, the burden of input by the user can be reduced.

The management computer 21 determines the number of registered images that are to be displayed by splitting the display section of the cellular phone unit 30, based on the resembling degree, generates display screen data that displays the registered images of the determined number, and sends the data to the cellular phone unit 30. Therefore, it becomes possible to display a plurality of registered images to the display section of the cellular phone unit 30, which is limited in size.

Based on the resembling degree, the management computer 21 determines the number of registered images that are to be split-displayed on the display section of the cellular phone unit 30, using a predetermined function. Therefore, based on the resembling degree, the display section of the cellular phone unit 30 can display split-images, and it becomes possible to display the registered images concerning the photographed subject of the same type of photographed subject as the reference image, so that it can easily be found by the user.

Using the image photographed by the digital camera loaded in the cellular phone unit 30, as the reference image, the registered images of the same type of photographed subject can be searched, to register the attribute information that is correlated with the registered images, and the photographed image, being correlated with each other. By splitting the display unit in accordance with the resembling degree, and displaying the searched registered images, with even a small-sized display-unit of the cellular phone unit 30, the same type of photographed subject of the photographed image, as the photographed subject of the registered images can be found effectively, using the small-sized display unit.

The above embodiment may be changed to the below mode.

For example, in a case where the resembling degree of the registered image is high, the number of displays of the image on one screen of the cellular phone unit 30 is reduced to display a larger image, and in a case where the resembling degree of the registered images that are to be displayed is low, the number of images that are to be displayed on one screen is increased, to display smaller images. In a case where the user determines that the searched photographed subject of the image with a high resembling degree, is not the same type as the photographed subject of the reference image, and displays images with a low resembling degree, on the cellular phone unit 30, more images are displayed on one screen, concerning the images with a low resembling degree. By doing so, based on the resembling degree of the displayed registered image with the reference image, it becomes possible to display the same type of photographed subject of the registered image as the photographed subject of the reference image, so that it can easily be found by the user.

The split-display method may be determined based on the designation from the cellular phone unit 30. By this, the registered image in the screen can be displayed by the number and size of the image requested by the user. Therefore, for example, in a case where the user requests to search the registered image of the same type of photographed subject as the photographed subject of the reference image, by displaying many images on the screen, and choosing therefrom, more images can be displayed on the screen. In a case where the user requests that the registered images are displayed at a predetermined size, the registered images can be displayed meeting the request of that size.

Based on the resembling degree of the registered image, the split-display method may be determined, using a different function than the function using only the resembling degree of the registered image with the highest resembling degree. For example, the split-display method may be determined based on the number of registered images that are in a predetermined range from the most highest resembling degree. By this, in a case where there are a plurality of registered images that have the same resembling degree, the registered images are displayed on one screen, so that the user can select therefrom. Therefore, the registered image of the photographed subject with the same type of photographed subject as the reference image, can be found more easily by the user.

The management computer 21 may automatically register the correlation of the reference image and the attribute information. In this case, the most likely attribute information may be specified by inputting the resembling degree of the registered image extracted by the resembling image search, to a predetermined function. For example, registered images, with a resembling degree equal to or higher than 60 percent, are extracted, and based on the extracted number of images, the attribute information to be correlated may be specified. By this, the reference image and the attribute information can be automatically correlated.

Also, for example, conceding each registered image, an URL designating the site of the provider of that registered image is stored, and the user can link to the site of the provider of the registered image, concerning the selected registered image. By this, the user can obtain more detailed information based on the reference image.

In the above embodiment, the image management system 20 manages image data of plants. However, the photographed subject of the image data that is managed, may be of any kind. For example, it may be natural objects such as birds, etc., or artificial objects such as clothes, etc. For example, in a case where information of clothes, etc., is to be provided, information concerning the sales place, and price, etc., may be provided. In this case, the specialized field of each confirmer is registered, and confirmation concerning the image corresponding to that specialized field may be carried out.

Also, the keyword search does not have to be carried out. Or, the search keyword may be input from the cellular phone unit 30.

Confirmation concerning the same image may be requested to a plurality of confirmers. In this case, the confirmation result by the confirmer who responded the fastest may be adopted. By this, confirmation by the confirmer being late, and the disclosure being delayed can be prevented.

Based on a plurality of confirmation results, it may be determined whether the image is to be a disclosure target or not. By this, disclosing an image that has correlated a mistaken attribute information, due to mistaken confirmation, as a registered image, can be prevented.

In the above embodiment, the cellular phone unit 30 that has a digital camera function embedded, is used as the referer terminal. However, other computer terminals such as a PDA (Personal Digital Assistant), etc., can be used. Concerning the reference image, an image data photographed by a digital camera, etc. may be used by transferring the image data to the computer terminal.

### Second Embodiment

Below, a second embodiment of the present invention will be described. In the present embodiment, an information providing system which provides information for specifying a plant that is photographed as a photographed subject, will be described.

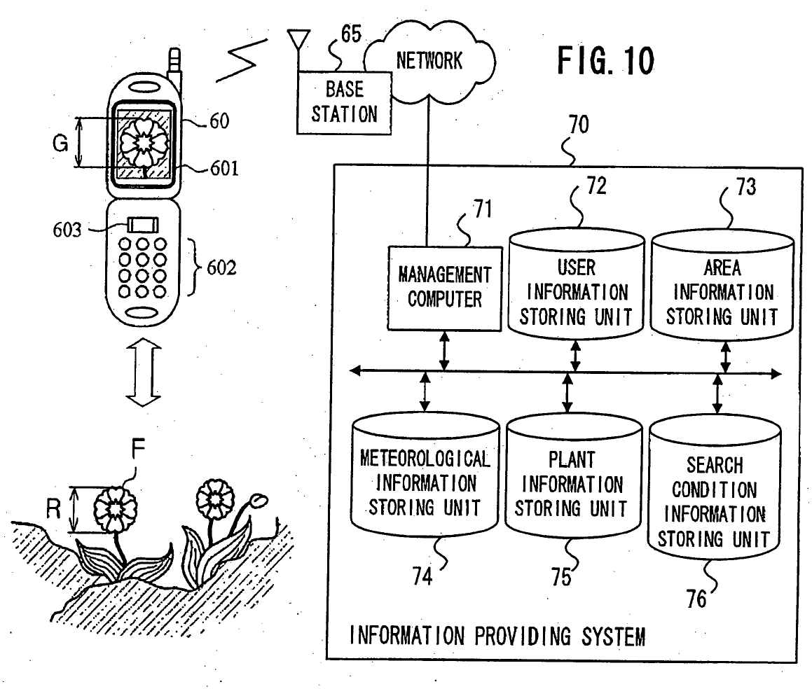

As shown in FIG. 10, in the present embodiment, a cellular phone unit 60 is used as a user terminal. The cellular phone unit 60 has a photographing mechanism such as a camera, etc., embedded therein, photographs a photographing subject using this photographing mechanism, and generates image data. In the cellular phone unit 60, the focal length and the photographing distance of the photographing mechanism can be adjusted.

The cellular phone unit 60 comprises a display section 601, which displays a photographed image, or received data. The cellular phone unit 60 also comprises a dial number button 602 and a function button 603. By using the dial number button 602, various data can be input. The function button 603 includes a pointer moving function and a clicking function. By carrying out direction indication using the function button 603, a pointer can be moved, and by pushing the function button 603, an item that the pointer is indicating, can be selected. Further, the cellular phone unit 60 has a gyro that measures the direction when the photographing is carried out, and the horizontal angle, embedded therein. Also, the cellular phone unit 60 comprises a GPS (Global Positioning System) function for specifying the position (longitude and latitude) of the cellular phone unit 60.

The cellular phone unit 60 is connected to an information providing system 70 via a cellular phone line network N that is connected to a base station 65. By carrying out receiving/sending of data from/to the base station 65, the cellular phone unit 60 can carry out receiving/sending of data from/to the information providing system 70, via the network N of the cellular phone line network, etc.

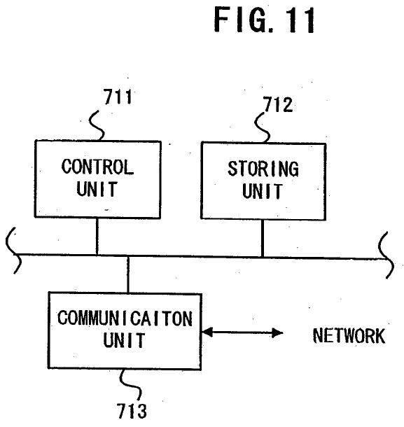

The information providing system 70 comprises a management computer 71. For example, as shown in FIG. 11, the management computer 71 has a control unit 711 including a CPU, a RAM, and a ROM, etc., a storing unit 712 including a hard disk, etc., and a communication unit 713, etc., that controls communication with another computer via the network. By the control unit 711 executing the program, etc., stored in the storing unit 712, a receiving unit, an obtaining unit, an attribute matching unit, an image matching unit, and a sending unit are realized.

The receiving unit carries out processing of receiving a photographed image of a photographing subject, and photographing condition information from the cellular phone unit. The obtaining unit carries out processing for obtaining information relating to the photographed subject, from the received photographing condition information. The attribute matching unit carries out processing of matching the obtained information related to the photographed subject, with attribute information registered in a database. The image matching unit carries out processing of matching the received photographed image with the images registered in the database, and specifying the registered image that corresponds to the photographed subject, based on the matching result. The sending unit reads the attribute information that is registered correlated with the specified registered image, from the database, and sends the information to the cellular phone unit.

The management computer 71 of the information providing system 70 is connected to each database (user information storing unit 72, area information storing unit 73, meteorological information storing unit 74, plant information storing unit 75 as picture book data storing means, and search condition information storing unit 76).

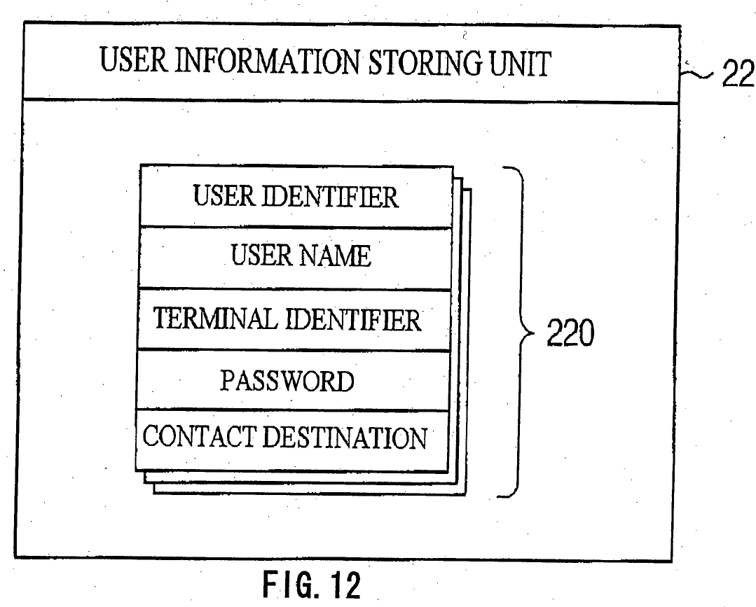

As shown in FIG. 12, the user information storing unit 72 stores user information 720 concerning the user who receives the present service. The user information 720 is stored when the user carries out user registration for receiving the present service. The user information 720 includes data concerning, user identifier, user name, terminal identifier, password, and contact destination. In the data region of the user identifier, data of the identifier for specifying the user is stored. In the data region of the user name, data of the name of the user is stored. In the data region of the terminal identifier, data of the terminal identifier for specifying the cellular phone unit 60 of the user is stored. In the present embodiment, the cellular phone number and the e-mail address of the cellular phone unit 60 is used as the terminal identifier.

In the data region of the password, data of the password of the user is stored. This password is used for authenticating the user, when the user uses the information providing system 70. In the data region of the contact destination, data concerning the contact destination of the user is stored. In the present embodiment, the user's address is used as the contact destination.

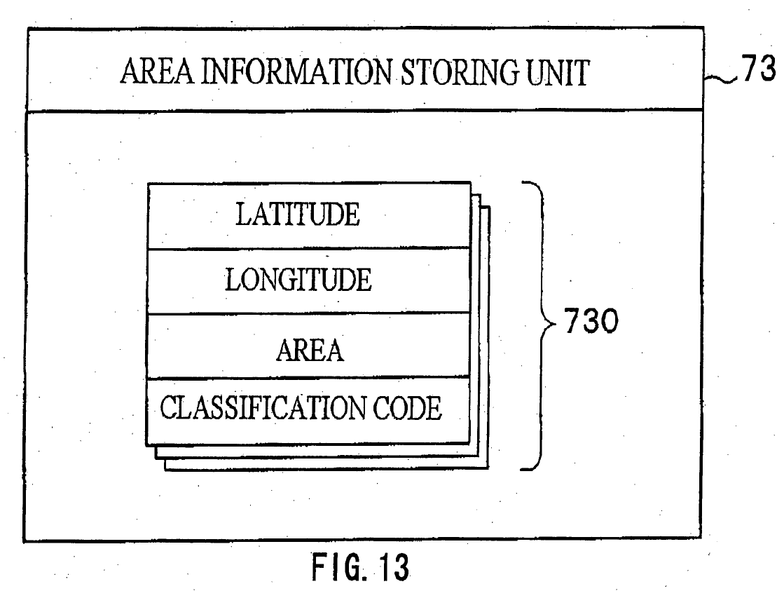

As shown in FIG. 13, area information 730 concerning area is stored in the area information storing unit 73. The area information 730 is registered in advance, based on for example, data obtained from sites of map companies. The area information includes data of latitude, longitude, area, and classification code. In the data region of latitude, data of latitude, for specifying area data and classification code data is stored. In the data region of longitude, data of longitude, for specifying area data and classification code data is stored. In the data region of area, data (area name, etc.) concerning area specified based on the latitude and longitude is stored. In the data region of the classification code, classification codes used for searching data concerning the habitat of the plants, are stored. The classification data indicates codes corresponding to classification such as for example, ¢coniferous forest zone near an altitude of 2000 m”.

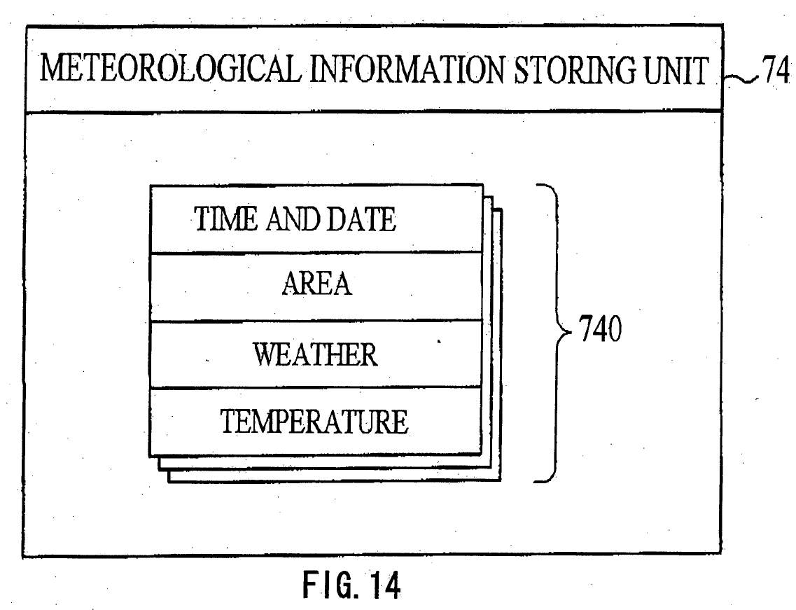

As shown in FIG. 14, meteorological information 740 concerning the observed weather is stored in the meteorological information storing unit 74. The meteorological information 740 is obtained from a meteorological information site, and stored. The meteorological information 740 includes data concerning time and date, area, weather and temperature. In the region of time and date data, data of the time and date (year, month, day, hour and minute) for specifying the weather data is stored. Via the data stored in the area data region, the area information 730 and the meteorological information 740 are correlated with each other. In the region of weather data, weather data specified based on time and date data and area data, is stored. Data stored in the weather data, is concretely, for example, “light rain”, “fair weather”, and “sunny”, etc. Data stored in the weather data region is specified based on time and date data and area data.

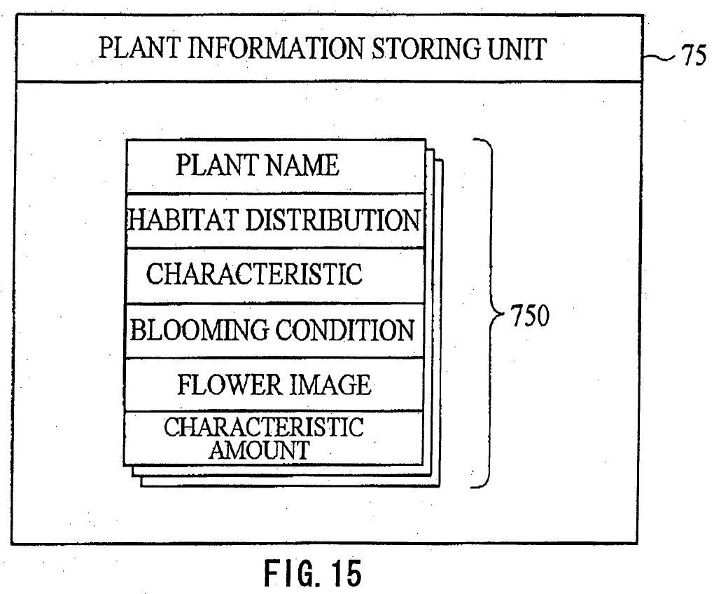

As shown in FIG. 15, plant information 750 concerning various plants, is stored in the plant information storing unit 75. Concerning the plant information 750, information of well-known plants are stored before the providing of the service of the information providing system 70 starts, and information of new plants are stored to the plant information storing unit 75 after the mode of life of that plant is made cleat. The plant information 750 includes data concerning, plant name, characteristic, blooming condition, flower image, and characteristic amount. In the present embodiment, the plant name, habitat distribution, characteristic, and blooming condition corresponds to the attribute information, and the flower image of the plant information 750 corresponds to image data. Data of the common name and academic name of the plant is stored in the habitat distribution data region. Via the data stored in the data region, the area information 730 and the plant information 750 are correlated. In the characteristic data region, data of the characteristic of the plant is stored. The characteristic is for example, the size of the flower, shape of the leaf, and whether there are/aren't thorns. In the data region of blossoming condition, data of the condition for the plant to bloom, is stored. This condition is for example, “temperature equal to or higher than 25 degrees Celsius”, and “during the day”. In the flower image data region, image data of the flower of the plant is stored. In the characteristic amount data region, characteristic amount obtained from the image of the flower image data is stored. Data of the characteristic amount of the image of the flower image data includes numerical value data of each item concerning the shape and color of the flower in the image.

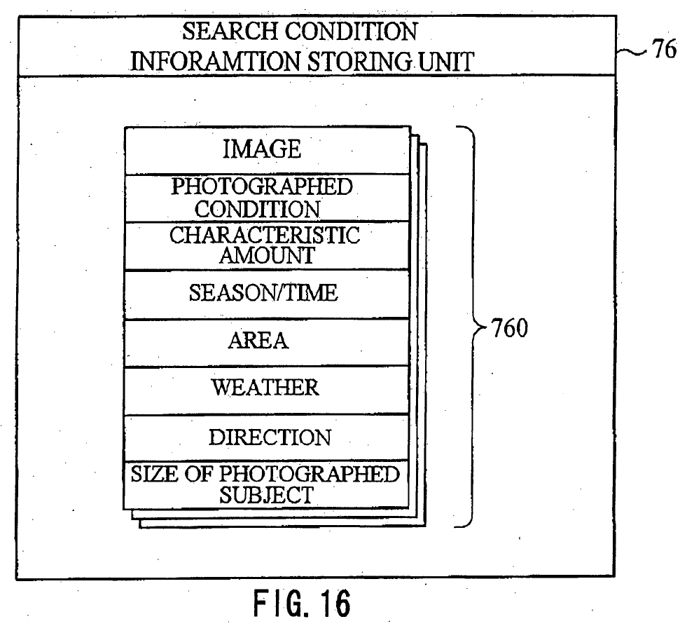

As shown in FIG. 16, the search condition information storing unit 76 stores search condition information 760 concerning search conditions used for specifying the photographed subject. Bach item of the search condition information 760 is stored when the management computer 21 obtains data of each search condition thereof. The search condition information 760 includes data of, image, photographed condition, characteristic amount, season/time, area, weather, direction, and size of photographed subject. In the present embodiment, season/time, area, weather, direction, and size of photographed subject correspond to the photographed subject information. Data concerning the image information including the photographed subject that is to be searched, is stored in the image data region. In the photographed condition data region, data (photographed condition data) of the photographed condition information attached to the image data is stored. In the characteristic amount data region, data of the characteristic amount of the image stored in the image data region is stored. Data of the characteristic amount is constituted including the value of each item, such as the shape, pattern, and color of the photographed subject in the image. In the season/time data region, data concerning the season and time that the image was photographed, is stored.

In the area data region, data of the area where the image was photographed, is stored. In the meteorological data region, meteorological data of the time the image was photographed, is stored. Concretely, meteorological data is data of weather, and temperature, etc. In the direction data region, data of the direction that the image was photographed, is stored. In the photographed subject size data region, data of the actual size of the photographed subject is stored.

Next, photographed subject information providing processing by the information providing system 70, will be described. Here, as shown in FIG. 10, a case where a user finds a flower F, and photographs the flower F using the cellular phone unit 60, and looks up the name of that flower, will be described.

First, the user photographs the flower that he/she wants to know the name of. Concretely, the user operates the function button 603 of the cellular phone unit 60, and uses the photographing mechanism to display the flower F, which is the photographed subject, at the center of the display unit 601. At this time, the cellular phone unit. 60 adjusts the focus to the flower F, which is the photographing subject. Then, the user operates function button 603 to photograph the flower F. The cellular phone unit 60 generates and stores image data concerning the photographed flower F. At this time, other than ordinary image recording formats such as JPEG and TIFF, other formats such as the Exif format can be used as the image data stored in the cellular phone unit 60. Here, the Exif format is an image recording format of the digital camera, and photographed condition information, etc., is stored in a predetermined form, as Exif tag information. In the present embodiment, a case where image data of Exif format is sent, will be described. In the present embodiment, concretely, photographed condition information includes data concerning the set pixel number, focal length, photographing distance, gyro value of the cellular phone unit 60, date and time that the image was photographed, and the position where the image was photographed (latitude and longitude of the cellular phone unit 60).

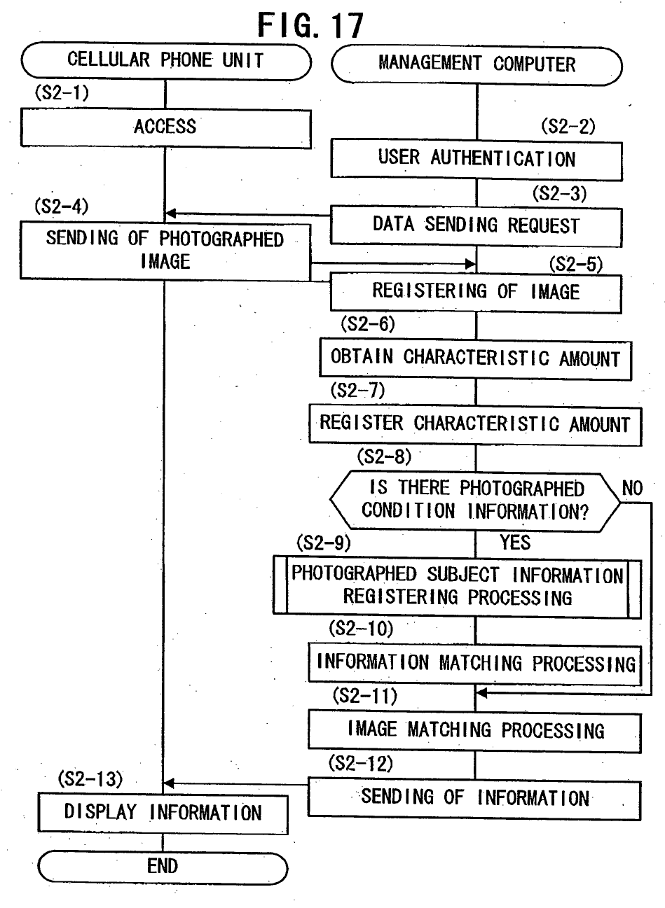

Next, as shown in FIG. 17, the user operates the dial number button 602 and the function button 603 of the cellular phone unit 60, to access to the information providing system 70. Concretely, when the cellular phone unit 60 connects to the information providing system 70, the user receives a sending request of password, from the information providing system 20 (step S2-1). In accordance with this request, the cellular phone unit 60 displays an input screen on the display section 601, and urges input of the password to the user. When the input of the password ends, and the send button is selected, the cellular phone unit 60 sends the input password data to the information providing system 70. At this time, the cellular phone unit 60 sends data concerning the terminal identifier of the cellular phone unit 60, together with the password data.

Next, the control unit 711 of the management computer 71 carries out user authentication (step S2-2). Concretely, the control unit 711 extracts the user information 720 that corresponds to the received terminal identifier, from the user information storing unit 72. Then, the control unit 711 matches the password of the extracted user information 720 with the received password. As a result of matching, in a case where the two passwords match, the control unit 711 ends the user authentication. In a case where the two passwords do not match, the control unit 711 notifies so, to the cellular phone unit 60, and ends processing.

In a case where user authentication ends, the control unit 711 requests sending of image data, which is the search target, to the cellular phone unit 60 (step S2-3). The cellular phone unit 60 carries out sending processing of photographed image data (step S2-4). Here, the cellular phone unit 60 reads the photographed image information of the flower F stored thereto, in accordance with instruction from the user, and sends the information to the management computer 71. In the present embodiment, a case where the photographed condition information is included in the sent photographed image information, is assumed.

Receiving the photographed image information, the control unit 711, registers the image data (step S2-5). Concretely, the control unit 711 extracts image data from the received photographed image information, and stores the data to the image data region of the search condition information storing unit 76. Then, the control unit 711 extracts data of the photographed condition information from the received photographed image information, and stores the data to the photographed condition data region of the search condition information storing unit 76, correlating the data with the image that is registered before. Next, the control unit 711 obtains (extracts) data of characteristic amount, concerning the registered image data (step S2-6). Concretely, the control unit 711 specifies the flower, which is the photographed subject, from the color distribution of the image. Namely, the control unit 711 extracts data of outline form and color of the flower in the photographed image. Also, the control unit 711 specifies the size of the flower in the image from the outline form and color of the image. Then, the control unit 711 registers the data of the obtained characteristic amount concerning the photographed image, to the characteristic amount data region of the search condition information storing unit 76 (step S2-7). Next, the control unit 711 determines whether photographed condition information is included in the received photographed image information (step S2-8).

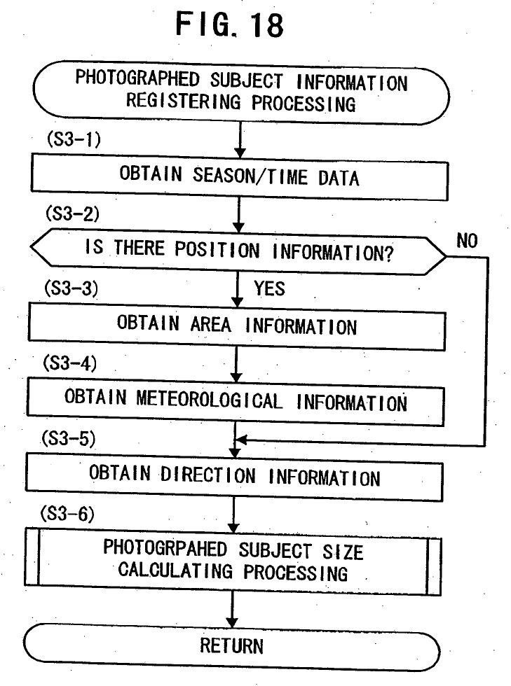

In a case where photographed condition information is included in the received image data (step S2-8 YES), the control unit 711 carries out photographed subject information registering processing, such as shown in FIG. 18 (step 82-9). First, the control unit 711 obtains data of the photographed season and time from the photographed condition information, and registers the data (step 83-1). Concretely, the control unit 711 extracts the photographed date and time data from the received photographed condition information, and specifies a season and time corresponding to the date and time data. Then, the control unit 711 stores the data in the season/time data region of the search condition information storing unit 76, correlating it with the image registered before.

Next, the control unit 711 determines whether position information is included the photographed condition information (step 83-2). In a case where position information is included in the photographed condition information (step S3-2: YES), the control unit 711 obtains area information based on the position information, and registers the information (step 83-3). Concretely, the control unit 711 obtains the area data and the classification data corresponding to the position information, from the area information storing unit 73, and stores the data to the area data region of the search condition information storing unit 76, correlated with the image that is registered before. Further the control unit 711 obtains meteorological information, and registers the information (step S3-4). Concretely, based on the area data obtained in step S3-3 and date and time data extracted from the photographed condition information, the control unit 711 extracts meteorological information 740 corresponding thereto, from the meteorological information storing unit 74. By this, the control unit 711 obtains data of the weather and temperature of the time that the image data was photographed. Then, the control unit 711 stores the data relating to the obtained weather and temperature to the meteorological data region of the search condition information storing unit 76, correlating the data with the image that is registered before. In a case where position information is not included in the photographed condition information (step S3-2: NO), the control unit 711 does not execute steps S3-3 to S34.

Next, the control unit 711 obtains the direction information, and registers the information (step S3-5). Concretely, the control unit 711 extracts the gyro value from the photographed condition information of the image data. The control unit 711 stores the calculated position information to the direction data region of the search condition information storing unit 76, correlating the information with the image that is registered before. At this time, together with the direction of north, east, south, and west, the angle towards the horizontal plane is calculated.

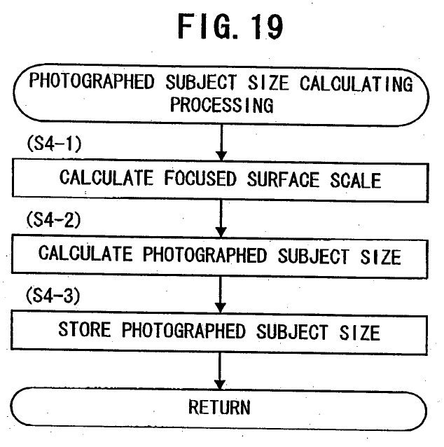

Then, the control unit 711 carries out photographed subject size calculating processing (step S3-6). The photographed subject size calculating processing will be described with reference to FIG. 19. First, the control unit 711 calculates a focused surface scale (step S4-1). Concretely, the control unit 711 extracts the photographed distance and focal length from the photographed condition information of the image data. Then, the control unit 711 calculates the focused surface scale in the photographing range, by the focal length, photographing distance, and angle of photography. Next, the control unit 711 calculates the photographed subject size (step S4-2). Concretely, the control unit 711 calculates the size of the actual photographed subject, by the size of the photographed subject in the image by the contrast adjustment and color gamut of the image of the search condition information, and the focused surface scale calculated in step S4-1. Here, as shown in FIG. 10, in a case where the diameter of the “flower” in the screen is diameter G, the control unit 711 calculates the diameter R of the actual flower F using the scale of the focused surface. Then, the control unit 711 stores the calculated size of the photographed subject to the photographed subject size of the search condition information storing unit 76, correlating the size with the image registered before. In this way, the management computer 71 obtains information of the diameter of the flower F of the photographed subject, in the photographed subject size calculating processing.

When the photographed subject size calculating processing (step S3-6) ends, the control unit 711 ends the photographed subject information registering processing (step S2-9), and returns to the processing procedure sown in FIG. 17.

Next, the control unit 711 carries out information matching processing (step S2-10). Concretely, based on the information registered in the search condition information storing unit 76 in the photographed subject information registering processing in step S2-9, the control unit 711 searches the plant that corresponds to this information, from the plant information 750 stored in the plant information storing unit 75. In the present embodiment, the management computer 71 extracts the corresponding plant information 750 from the plant information storing unit 75, based on the season and time of blooming, and information concerning direction and the diameter R of the flower F. In a case where area information is included in the information registered in step S2-9, the control unit 711 extracts plant information 750 which includes the obtained area data in the habitat distribution, from the extracted plant information 750. Further, the control unit 711 extracts plant information corresponding to the meteorological information obtained in step S3-4.

In a case where photographed condition information is not included in the photographed image information received from the cellular phone unit 60 (step S2-8: NO), the control unit does not execute steps S2-9 to S2-10.

Next, the control unit 711 carries out image matching processing (step S2-11). Concretely, the control unit 711 compares the characteristic amount of flower image of the plant information 750 which is extracted as being corresponding in the information matching processing in step S2-10, and the obtained characteristic amount concerning the image received from the cellular phone unit 60. As a result of the comparison, the control unit 711 specifies the plant which the resembling degree of the image is the highest. At this time, specifying of the plant is carried out based on the outline form and color distribution of the image. After carrying out specifying of the plant, the control unit 711 reads a part or the whole plant information 750 of that plant. Next, the control unit 711 sends the information of the specified plant to the cellular phone unit 60 (step S2-12). At this time, the information that the control unit 711 sends, includes information such as for example, name of the plant, characteristic, and blooming condition.

The cellular phone unit 60 that receives the information displays the information of the specified plant to the display section 601 of the cellular phone unit 60 (step S2-13). By this, the user can obtain information concerning the flower F that he/she looked at in a valley.

As described above, according to the present embodiment, information concerning the photographed subject can be provided effectively, with a high accuracy, towards the user.

In the present embodiment, the management computer 71 extracts the plant information 750 that corresponds to the information concerning the season and time for blooming, and direction and diameter of the flower F, obtained from the photographed condition information. Further, the management computer 71 obtains the plant information 750 that resembles the most, from the extracted plant information 750, based on the characteristic amount of the image received from the cellular phone unit 60. Namely, the management computer 71 specifies the plant information 750 corresponding to the photographed subject, by both the image received from the cellular phone unit 60, and the information concerning the photographed subject obtained from the photographed condition information. By this, information corresponding to the photographed subject in the received image, can be provided to the user with a higher accuracy. Because the management computer 71 obtains the information concerning the photographed subject from the photographed condition information included in the image data, search accuracy can be improved without burdening the user to input data.

The management computer 71 calculates a focused surface scale from the focal length and photographing distance included in the photographed condition information, and calculates the diameter R of the actual flower F from the focused surface scale and the diameter G in the image of the flower F. Therefore, specifying of the flower F can be carried out with referring to the size of the flower F.

The management computer 71 obtains data of the season and time when the flower F was photographed, from the information concerning the photographed time included in the photographed condition information. The blooming season and time differ according to each plant. Therefore, the management computer 71 carries out specifying of the flower F, based on data of the season and time that the subject was photographed.

Also, the direction of blooming differs according to each plant (for example, sunflowers bloom towards the direction of the sun). Based on this matter, the management computer 71 calculates the direction that the photographed subject was photographed, based on the gyro value included in the photographed condition information, and can specify the flower F based on the calculated direction information.

The habitat region of plants differ. Based on this matter, the management computer 71 obtains the area data corresponding to the position information and classification data, from the area information storing unit 73, to specify the flower F, while referring to the photographed place, i.e., the information of the area where the plant inhabits.

There are cases where the blooming situation of plants differ, according to the weather. Based on this matter, the management computer 71 obtains weather information from the photographed condition included in the photographed condition information and information concerning the photographed place, and specifies the flower F while referring to the weather information.

The above embodiment may be changed as below.

For example, the type of plant may be specified by also referring to the information concerning photographed time included in the photographed condition information. The height of plants differ according to season Therefore, the management computer 21 can specify the type of plant based on when the subject was photographed, such as season and time, together with the size of the photographed subject.

Also, for example, the image including the photographed subject that is the search target may be received, by storing the image that is to be searched to a predetermined server in advance, and receiving designation of the image data that is to be searched, from the cellular phone unit 60.

The device for sending the image data is not limited to the cellular phone unit 60, and for example, image data photographed by a digital camera may be sent using a personal computer.

In the above embodiment, a case where a plant which is a photographed subject is specified, is described. However, the photographed subject is not limited to plants, and may be other objects, such as animals, mineral substances, astronomical objects, and vehicles, etc. For example, in a case of fishes that are called by different names at different stages of growth, the name can be specified by the size and season. In a case of mineral substances, the name can be specified by the area that the mineral substance was photographed, and the photographed image.

In the above embodiment, the management computer 71 sends plant information 750 concerning the specified flower F to the cellular phone unit 60. However, it is not limited to this, and it may be that the management computer 71 sends only a part of the plant information 750, for example the plant name.

Obtainment of the position information by the cellular phone unit 60 is not limited to that of using GPS function. For example, in a case where the cellular phone unit 60 is a PUS terminal (Personal Handyphone System), the position information of the base station thereof is obtained, and by converting the position information of the base station to latitude and longitude, the position information may be stored in the image information of the photographed subject, as photographed condition data.

The cellular phone unit 60 may be a cellular phone unit that does not have a gyro and a GPS function embedded. In this case, searching may be carried out using information obtained from photographed condition data other than the data obtained by gyro and GPS function.

As a program and recording medium which store data for realizing the function of the present invention, concretely, a CD-ROM (-R/-RW), a magneto optical disk, a DVD-ROM, a FD, a flash memory, a memory card, a memory stick, and other various ROM or RAM, etc., may be used. By distributing the recording medium, and installing the program, etc., to a computer, a management computer and a cellular phone unit, etc., that execute the above described processing, may be structured. Also, the program may be stored in a disk device that the server device in the network comprises, such as the Internet, and downloaded, etc., to a computer embedding the program on a carrier wave.

In a case where the OS carries out parts of the processes, or the OS constitutes a part of a single constituting element of the present invention, those programs excluding the part may be stored in the recording medium. Even in this case, it is premised that the programs for executing the individual functions or steps that are executed by a computer should be stored in the recording medium in the invention.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-341939, and Japanese Patent Application No. 2003-342438, both, filed on September 30, 2003, and including specification, claims, drawings and summary. The disclosures of the above Japanese Patent Applications are incorporated herein by reference in its entirety.

1. A computer for generating a database used in an electronic picture book service which provides information relating to a received photographed image, to the senders wherein
an image and attribute information of the image are correlated with the database, and
the computer comprises:
a receiving unit which receives a reference image from a reference terminal, via a network;
a calculating unit which calculates the characteristic amount of said received reference image;
a resembling degree calculating unit which calculates the resembling degree of images, based on the calculated characteristic amount of said reference image, and the characteristic amount of the image registered in the database;
a specifying unit which specifies the registered image of the same photographed subject as said reference image, based on said calculated resembling degree; and
a registering unit which registers attribute information correlated with said specified registered image, to said database, correlating the information to said reference image.

2. The computer according to claim 1, wherein:
said specifying unit temporarily registers the attribute information correlated with said specified registered image, correlating the information with said reference image, and sends information urging confirmation of the temporarily registered content, to the terminal of the confirmer; and
said registering unit receives a confirmation result from the terminal of said confirmer, and changes said temporary registration to an official registering, based on the confirmation result.

3. The computer according to claim 2, wherein said specifying unit:
extracts the registered images that have a resembling degree equal to or higher than a predetermined value, based on said calculated resembling degree;
sends said extracted registered images to a referer terminal;
receives information indicating the registered image that the referer designates from said extracted registered images; and
temporarily registers the attribute information that is correlated with the registered image that said received information indicates, correlating the information with said reference image.

4. The computer according to claim 3, wherein said specifying unit:
determines the number of registered images that are to be displayed on a screen, based on said calculated resembling degree; and
generates screen data that displays said determined number of registered images of said extracted registered images, and sends the data to said referer terminal.

5. The computer according to claim 1, wherein:
said receiving unit receives photographed information concerning the reference image, together with the reference image; and
said resembling degree calculating unit searches the registered images correlated with a search key, setting the photographed information as the search key, and respectively calculates the resembling degree with said reference image, concerning the searched registered images.

6. The computer according to claim 1, wherein said referer terminal is a cellular phone unit that has a digital camera embedded.

7. A computer that is connected to a database that has an image of an object and attribute information correlated, comprising:
a receiving unit which receives a photographed image of a photographed subject and photographed condition information, from a user terminal;
an obtaining unit which obtains information relating to said photographed subject, from said received photographed condition information;
an attribute matching unit which matches the information relating to said obtained photographed subject, with the attribute information registered in said database;
an image matching unit which matches said received photographed image with the images registered in said database, based on the matching result of information relating to said photographed subject, and specifies the registered image corresponding to the photographed subject; and
a sending unit which reads the attribute information that is registered being correlated with said specified registered image, from said database, and sends the information to said user terminal.

8. The computer according to claim 7, wherein:
said photographed condition information includes data of the photographed distance to the photographing subject, and focal length at the time of photographing;
said obtaining unit obtains the actual size of said photographed subject, based on said photographing distance and said focal length, as information relating to said photographed subject; and
said attribute matching unit matches information of the size of said photographed subject, with said attribute information.

9. The computer according to claim 7, wherein:
said photographed condition information includes data concerning the photographed time;
said obtaining unit obtains information of said photographed time as information relating to said photographed subject; and
said attribute matching unit matches the information of said photographed time with said attribute information.

10. The computer according to claim 7, wherein:
said photographed condition information includes data concerning photographed direction;
said obtaining unit obtains photographing direction, based on data concerning said photographing direction, as information relating to said photographed subject; and
said attribute matching unit matches information of said photographing direction with said attribute information.

11. The computer according to claim 7, wherein:
said photographed condition information includes information concerning photographing place;
said obtaining unit obtains information of said photographing place, as information relating to said photographed subject; and
said attribute matching unit matches information of said photographing place with said attribute information.

12. The computer according to claim 7, wherein:
said photographed condition information includes information concerning photographing time and photographing place;
said obtaining unit obtains weather information based on information concerning said photographing time and said photographing place, as information relating to said photographed subject; and
said attribute matching unit matches said weather information with said attribute information.

13. A database generating method for generating a database used in an electronic picture book service which provides information relating to a received photographed image, to the sender, wherein a computer;
receives a reference image from a reference terminal, via a network;
calculates the characteristic amount of said received reference image;
calculates the resembling degree of images, based on the calculated characteristic amount of said reference image, and the characteristic amount of the image registered in the database;
specifies the registered image of the same photographed subject as said reference image, based on said calculated resembling degree; and
registers attribute information correlated with said specified registered image, to said database, correlating the information to said reference image.

14. The database generating method for electronic picture book service according to claim 13, wherein said computer:
temporarily registers the attribute information correlated with said specified registered image, correlating the information with said reference image;
sends information urging confirmation of the temporarily registered content, to the terminal of the confirmer; and
receives a confirmation result from the terminal of said confirmer, and changes said temporary registration to an official registering, based on the confirmation result,
in specifying the registered image that has the same photographed subject as said reference image.

15. The database generating method for electronic picture book service according to claim 14, wherein said computer:
extracts the registered images that have a resembling degree equal to or higher than a predetermined value, based on said calculated resembling degree;
sends said extracted registered images to a referer terminal;
receives information indicating the registered image that the referer designates from said extracted registered images; and
temporarily registers the attribute information that is correlated with the registered image that said received information indicates, correlating the information with said reference image,
in temporarily registering said reference image.

16. The database generating method for electronic picture book service according to claim 14, wherein said computer:
determines the number of registered images that are to be displayed on a screen, based on said calculated resembling degree; and
generates screen data that displays said determined number of registered images of said extracted registered images, and sends the data to said referer terminal,
in sending the extracted registered image to the referer terminal.

17. The database generating method for electronic picture book service according to claim 13, wherein said computer:
receives photographed information concerning the reference image, together with the reference image;
searches the registered images correlated with a search key, setting the photographed information as the search key, and respectively calculates the resembling degree with said reference image, concerning the searched registered images,
in receiving the reference image from said referer terminal.

18. The database generating method for electronic picture book service according to claim 13, wherein said referer terminal is a cellular phone unit that has a digital camera embedded.

19. A photographed subject information providing method, wherein a computer, which is connected to a database that registers an image of an object and attribute information correlated, executes the steps of:
receiving a photographed image of a photographed subject and photographed condition information, from a user terminal;
obtaining information relating to said photographed subject, from said received photographed condition information;
matching the information relating to said obtained photographed subject, with the attribute information registered in said database;
matching said received photographed image with the images registered in said database, based on the matching result of information relating to said photographed subject, and specifying the registered image corresponding to the photographed subject; and
reading the attribute information that is registered being correlated with said specified registered image, from said database, and sending the information to said user terminal.

20. The photographed subject information providing method according to claim 19, wherein:
said photographed condition information includes data of the photographed distance to the photographing subject, and focal length at the time of photographing;
said computer obtains the actual size of said photographed subject, based on said photographing distance and said focal length, in obtaining information relating to said photographed subject; and
said computer matches information of the size of said photographed subject, with said attribute information, in matching information related to said photographed subject.

21. The photographed subject information providing method according to claim 19, wherein:
said photographed condition information includes data concerning the photographed time;
said computer obtains information of said photographed time as information relating to said photographed subject, in obtaining information related to said photographed subject; and
said computer matches the information of said photographed time with said attribute information, in matching information related to said photographed subject.

22. The photographed subject information providing method according to claim 19, wherein:
said photographed condition information includes data concerning photographed direction;
said computer obtains photographing direction, based on data concerning said photographing direction, as information relating to said photographed subject, in obtaining information related to said photographed subject; and
said computer matches information of said photographing direction with said attribute information, in matching information related to said photographed subject.

23. The photographed subject information providing method according to claim 19, wherein:
said photographed condition information includes information concerning photographing place;
said computer obtains information of said photographing place, as information relating to said photographed subject, in obtaining information related to said photographed subject; and
said computer matches information of said photographing place with said attribute information, in matching information related to said photographed subject.

24. The photographed subject information providing method according to claim 19, wherein:
said photographed condition information includes information concerning photographing time and photographing place;
said computer obtains weather information based on information concerning said photographing time and said photographing place, as information relating to said photographed subject, in obtaining information related to said photographed subject; and
said computer matches said weather information with said attribute information, in matching information related to said photographed subject.

25. A computer readable recording medium that stores a program for controlling a computer to execute:
a step of receiving a reference image from a reference terminal, via a network;
a step of calculating the characteristic amount of said received reference image;
a step of calculating the resembling degree of images, based on the calculated characteristic amount of said reference image, and the characteristic amount of the image registered in the database;
a step of specifying the registered image of the same photographed subject as said reference image, based on said calculated resembling degree; and
a step of registering attribute information correlated with said specified registered image, to said database, correlating the information to said reference image.

26. A computer readable recording medium that stores a program for controlling a computer to execute:
a step of receiving a photographed image of a photographed subject and photographed condition information, from a user terminal;
a step of obtaining information relating to said photographed subject, from said received photographed condition information;
a step of matching the information relating to said obtained photographed subject, with the attribute information registered in said database;
a step of matching said received photographed image with the images registered in said database, based on the matching result of information relating to said photographed subject, and specifying the registered image corresponding to the photographed subject; and
a step of reading the attribute information that is registered being correlated with said specified registered image, from said database, and sending the information to said user terminal.

27. A computer data signal embedded in a carrier wave, indicating a program for controlling a computer to execute:
a step of receiving a reference image from a reference terminal, via a network;
a step of calculating the characteristic amount of said received reference image;
a step of calculating the resembling degree of images, based on the calculated characteristic amount of said reference image, and the characteristic amount of the image registered in the database;
a step of specifying the registered image of the same photographed subject as said reference image, based on said calculated resembling degree; and
a step of registering attribute information correlated with said specified registered image, to said database, correlating the information to said reference image.

28. A computer data signal embedded in a carrier wave, indicating a program for controlling a computer to execute:
a step of receiving a photographed image of a photographed subject and photographed condition information, from a user terminal;
a step of obtaining information relating to said photographed subject, from said received photographed condition information;
a step of matching the information relating to said obtained photographed subject, with the attribute information registered in said database;
a step of matching said received photographed image with the images registered in said database, based on the matching result of information relating to said photographed subject, and specifying the registered image corresponding to the photographed subject; and
a step of reading the attribute information that is registered being correlated with said specified registered image, from said database, and sending the information to said user terminal.
